(19) United States
(12) Patent Application Publication
(10) Pub. No.: US 2015/0355420 A1
(43) Pub. Date: Dec. 10, 2015

(54) COUPLING DEVICE HAVING A STAMPED STRUCTURED SURFACE FOR ROUTING OPTICAL DATA SIGNALS

(71) Applicant: NANOPRECISION PRODUCTS, INC., El Segundo, CA (US)

(72) Inventors: Shuhe LI, Pasadena, CA (US); Robert Ryan VALLANCE, Newbury Park, CA (US); Michael K. BARNOSKI, Pacific Palisades, CA (US)

(21) Appl. No.: 14/695,008

(22) Filed: Apr. 23, 2015

Related U.S. Application Data
(63) Continuation-in-part of application No. 13/861,273, filed on Apr. 11, 2013.
Application No. 13/861,273 is a continuation-in-part of application No. 13/786,448, filed on Mar. 5, 2013.
(60) Provisional application No. 61/623,027, filed on Apr. 11, 2012.
(60) Provisional application No. 61/699,125, filed on Sep. 10, 2012.
(60) Provisional application No. 61/606,885, filed on Mar. 5, 2012.

(51) Int. Cl. G02B 6/42; B21D 22/02; G02B 6/43; G02B 6/36; G02B 6/32

(52) U.S. Cl. CPC G02B 6/4214; G02B 6/3648; G02B 6/4263; G02B 6/32; G02B 6/4228; G02B 6/43; B21D 22/02

(57) ABSTRACT

An optical coupling device for routing optical signals for use in an optical communications module, in which defined on a base are a structured surface having a surface profile that reshapes and/or reflect an incident light, and an alignment structure defined on the base, configured with a surface feature to facilitate positioning an optical component on the base in optical alignment with the structured surface to allow light to be transmitted along a defined path between the structured surface and the optical component. The structured surface and the alignment structure are integrally defined on the base by stamping a malleable material of the base. The alignment structure facilitates passive alignment of the optical component on the base in optical alignment with the structured surface to allow light to be transmitted along a defined path between the structured surface and the optical component. The structured surface has a reflective surface profile, which reflects and/or reshape incident light.

### PRIORITY CLAIM

This application is a continuation-in-part of U.S. patent application Ser. No. 13/861,273 filed on Apr. 11, 2013, which (a) claims the priority of U.S. Provisional Patent Application No. 61/623,027 filed on Apr. 11, 2012; (b) claims the priority of U.S. Provisional Patent Application No. 61/699,125 filed on Sep. 10, 2012; (c) is a continuation-in-part of U.S. patent application Ser. No. 13/786,448 filed on Mar. 5, 2013, which claims the priority of U.S. Provisional Patent Application No. 61/606,885 filed on Mar. 5, 2012. These applications are fully incorporated by reference as if fully set forth herein. All publications noted below are fully incorporated by reference as if fully set forth herein.

### BACKGROUND OF THE INVENTION

1. Field of the Invention

The present invention relates to optical signal transmissions, in particular a device for routing optical data signals for use in an optical communications module.

2. Description of Related Art

Given the increasing bandwidth requirements for modern day data transmission (e.g., for high definition video data), fiber optic signal transmissions have become ubiquitous for communicating data. Optical signals are transmitted over optical fibers, through a network of optical fibers and associated connectors and switches. The optical fibers demonstrate a significantly higher bandwidth data transmission capacity and lower signal losses compared to copper wires for a given physical size/space.

In fiber optic signal transmission, conversions of optical signals and electrical signals take place beyond the terminating end of the optical fiber. Specifically, at the output end of an optical fiber, light from the optical fiber is detected by a transducing receiver and converted into an electrical signal for further data processing downstream (i.e., optical-to-electrical conversion). At the input end of the optical fiber, electrical signals are converted into light to be input into the optical fiber by a transducing transmitter (i.e., electrical-to-optical conversion).

To couple the input/output of the optical fiber to the transmitter/receiver, optical elements such as lenses are required to collimate and/or focus light from a light source (e.g., a laser) into the input end of the optical fiber, and to collimate and/or focus light from the output end of the optical fiber to a photo diode detector. To achieve acceptable signal levels, optical fibers must be precisely aligned at tight tolerance to the transmitters and receivers, so that the optical fibers are precisely aligned to the optical elements supported with respect to the transmitters and receivers.

In the past, given the internal optical elements and structures needed to achieve the required optical alignments, the transmitters and receivers are provided with coupling structures having connection ports to which optical fibers are coupled using connectors terminating the optical fibers. Given optical fibers are brittle, they must be handled with care during and after physical connection to the transmitter and receiver structures. The transmitters and receivers and associated structures having the connection ports are therefore generally bulky, which take up significant space, thereby making them not suitable for use in smaller electronic devices.

Heretofore, the coupling structure for optical fibers and transmitters and receivers are generally quite expensive and comparatively large in size for a given port count.

Referring to U.S. Patent Application Publication No. 2003/223131A1, one category of coupling devices is referred to in the art as an optical subassembly (OSA) for an optoelectronic module, which includes a lens and/or an optoelectronic device, e.g., having a laser (i.e., a transmitter optical subassembly or TOSA) or a photoelectric receiver chip (i.e., a receiver optical subassembly ROSA). The components of the OSA are mounted on a silicon optical bench.

Further referring to U.S. Pat. No. 6,869,231, the optical bench is essentially a mounting block, which includes a plurality of openings for accurately mounting the various components to obtain acceptable optical alignment of the components, e.g., including one or more ball lenses, a semiconductor laser chip (in the case of a TOSA) or a package photodiode receiver (in the case of a ROSA), and other components, such as optical isolator, etc. The semiconductor laser chip is used to generate light signals for optical communication over an optical fiber. The photodiode receiver is used to receive light signals communicated over an optical fiber. The ball lens is used to focus light signals between an optical fiber and the optical transmitter/receiver. Another ball lens collimates the light output from the semiconductor laser. In a further disclosed embodiment, an optical transceiver includes the optical bench on which a receiver and a transmitter are mounted.

U.S. Pat. No. 8,103,140 discloses a silicon substrate optical system, in which the optical bench includes a silicon substrate that is etched to receive optical components, including an input optical fiber, a pump source, a photodiode, an output optical fiber, and other optical components.

Heretofore, some OSA includes a turning mirror to redirect optical signal. U.S. Pat. No. 8,168,939 discloses an OSA in the form of a light source assembly that supports direct coupling to a photonically enabled complementary CMOS chip. The OSA disclosed therein includes a laser, a microlens and a turning mirror mounted on an optical bench. The optical signal is reflected at an angle defined by the turning mirror, and transmitted out of the light source assembly to one or more grating couplers in the chip. The turning mirror may be integrated in a lid affixed to the optical bench or be integrated in the optical bench.

Chen et al. discloses a miniaturized bidirectional OSA using a silicon optical bench having a 45-degree micro-reflector to direct light from optical fibers to a photodiode and light from a VSCEL (vertical-cavity surface-emitting laser) to optical fibers. (Optical Engineering, 51(11), 115005 (Nov. 1, 2012)).

The above noted OSA all use a substrate (in particular a silicon substrate) that is precision etched to form the features on the optical bench for accurately affixing various components such as at least one ball lens, laser diode, photodiode, etc, to obtain acceptable optical alignment. The turning mirrors are formed by etching crystalline surfaces to define the reflective surfaces, or as separate prisms bonded to the etched bench. Further, fiducials are etched on the substrates, which are relied upon for alignment of the silicon optical bench to external components.

While micro-machining by silicon etching is well developed, it nonetheless involves complex fabrication steps and challenges using silicon as the working material. For example, the turning mirror is limited to a flat surface defining a turning angle conforming to the angle of the crystalline surface plane. Turning mirrors defined by the flat silicon surface planes are less efficient in redirecting light, and cannot reshape light beam. Ball lenses are therefore required to reshape the light beams, but beam shaping is limited using a ball lens. Given the difficulty to assemble other types of lenses on the silicon optical bench, ball lenses, which are symmetrical in all axes, can be used on the silicon optical bench. The separate components (e.g., mirrors, lens, etc.) are required to be accurately aligned and affixed to the silicon optical bench at tight tolerances, which involve challenging manufacturing steps.

The above noted drawbacks of existing coupling devices for optical data transmission are exacerbated in multi-channel optical data transmissions. Optical alignment of various optical components must be with sub-micron precision. The optical bench for optical alignment of the laser diode or photodiode, the ball lens and the mirror, and the connection and optical alignment of the optical fibers with respect to the light source/sensors must be fabricated, and the various components assembled on the optical bench, with sub-micron precision. As if parts, namely optical benches, with such precision levels were not challenging enough, for the parts to be economical produced, it should be done in a fully automated, high-speed process.

What is needed is an improved structure for a coupling device for routing optical signals, which may include physically and optically coupling input/output of an optical fiber, which improves manufacturability, ease of use, functionality and reliability at reduced costs.

### SUMMARY OF THE INVENTION

The present invention provides a coupling device (e.g., a stamped optic) for use in an optical communications module, which may include physically and optically coupling to an optical component, e.g., an input/output end of an optical fiber, for routing optical signals. The coupling device is implemented with a stamped reflective surface for routing/redirecting optical signals, and may include an integrated structure for physically and optically coupling an optical component, e.g., an optical fiber, to an optical receiver and/or transmitter, which improves manufacturability, ease of use and reliability at reduced costs, thereby overcomes many of the drawbacks of the prior art structures.

According to the present invention, the coupling device includes a stamped structured surface (e.g., a reflector) that functions as an optical element that directs light to/from another optical component, e.g., to/from the input/output ends of the optical fiber, by reflection (which may also include deflection and diffraction of incident light). The coupling device forms an optical bench for supporting the optical component, e.g., the optical fiber.

The structured reflective surface may be configured to be flat, concave or convex. In one embodiment, the structured reflective surface has a smooth surface with mirror finish. It may instead be a textured surface that is reflective. The structured reflective surface may have a uniform surface characteristic, or varying surface characteristics, such as varying degree of smoothness and/or textures, or a combination of various regions of smooth and textured surfaces making up the structured reflective surface. The structured reflective surface may have a surface profile and/or optical characteristic corresponding to at least one of the following equivalent optical element: mirror, focusing lens, diverging lens, diffraction grating, or a combination of the foregoing. The structured reflective surface may have more than one region corresponding to a different equivalent optical element (e.g., a central region that is focusing surrounded by an annular region that is diverging). Accordingly, depending on the geometry of the reflective surface, light can be redirected, and may further be reshaped, without requiring use of any lens (e.g., a ball lens). The structured reflective surface may thus be configured to, for example, collimate a diverging light beam into a collimated light beam and reflect the beam by a non-zero angle relative to an angle of incidence of the diverging light beam on the reflective surface. In one embodiment, the structured reflective surface is defined on an opaque material that does not transmit light through the surface.

In another aspect of the present invention, the coupling device also includes a structure for retaining an optical element, e.g., an optical fiber retention structure, which securely and accurately aligns the optical fiber with respect to the structured reflective surface. In one embodiment, the fiber retention structure includes at least one groove (or one or more grooves) that positively receives the optical fiber in a manner with the end of the optical fiber at a defined distance to and aligned with the structured reflective surface. The location and orientation of the structured reflective surface is fixed in relation to the fiber retention structure. In one embodiment, the fiber retention structure and the structured reflective surface are defined on the same (e.g., monolithic or unitary) structure of the coupling device. In an alternate embodiment, the fiber retention structure and the structure reflective surface are defined on separate structures that are coupled together to form the coupling device.

In one embodiment of the present invention, the structured reflective surface and fiber retention structure are defined by an open structure, which lends itself to mass production processes such as stamping, which are low cost, high throughput processes. In one embodiment, the structured reflective surface and the fiber retention grooves are formed by stamping a metal material. In one embodiment, the metal material may be chosen to have high stiffness (e.g., stainless steel), chemical inertness (e.g., titanium), high temperature stability (nickel alloy), low thermal expansion (e.g., Invar), or to match thermal expansion to other materials (e.g., Kovar for matching glass). Alternatively, the material may be a hard plastic or other hard polymeric material.

In one embodiment, the coupling device may be attached to an optical transmitter and/or receiver, with the structured reflective surface aligned to the light source (e.g., a laser) in the transmitter or to the detector (e.g., a photo diode) in the receiver. The transmitter/receiver may be hermetically sealed to the coupling device. The transmitter/receiver may be provided with conductive contact pads for electrical coupling to external circuitry. Given the fixed structured reflective surface and the fiber retention structure are precisely defined on the same coupling device, by aligning the light source in the transmitter or the light detector in the receiver to the structured reflective surface in the coupling device, the light source/detector would be precisely aligned to the input/output end of the optical fiber. In one embodiment, a method of precise alignment of the transmitter/receiver to the coupling device comprises superimposing complementary alignment marks provided on the transmitter/receiver and the coupling device.

In a further aspect of the present invention, silicon optical benches, such as those disclosed in the patents discussed in the Background section herein, can be replaced by a stamped optical bench.

In another aspect of the present invention, an optical fiber is structured as an active optical cable (AOC), which is a cable known in the art to have a transmitter at one terminal end of the optical fiber for electrical-to-optical conversion, and a receiver at another terminal end of the optical fiber for optical-to-electrical conversion.

The coupling device in accordance with the present invention overcomes many of the deficiencies of the prior art, which provides ease of use and high reliability with low environmental sensitivity, and which can be fabricated at low cost. The inventive coupling device may be configured for single or multiple channel optical data transmissions, e.g., to support a single or multiple fibers, for optical input, optical output or both (for bi-directional data communication).

In a further aspect of the present invention, silicon optical benches having particular defined optical paths through various optical elements and/or components can be replaced by a stamped optical bench in accordance with the present invention. Features and components defined on a silicon optical bench can be transformed to corresponding features defined on a stamped optical bench, and achieving a similar defined optical path with optical alignment at tight tolerances. Prior art silicon optical benches may be re-configured with stamped optical benches having similar defined optical paths. A stamped optical bench could have similar overall size and configuration, and similar footprint, compared to a corresponding silicon optical bench. The stamped optical bench would be backward compatible to replace a silicon optical bench in an optical subassembly. It is conceivable that stamped optical benches could be configured to have a smaller footprint and overall size than silicon optical benches. A stamped optical bench can effectively simplify the configuration of a silicon optical bench without compromising the desired defined optical path.

### BRIEF DESCRIPTION OF THE DRAWINGS

For a fuller understanding of the nature and advantages of the invention, as well as the preferred mode of use, reference should be made to the following detailed description read in conjunction with the accompanying drawings. In the following drawings, like reference numerals designate like or similar parts throughout the drawings.

FIG. 1 is a schematic diagram of the configuration of data transmission over an optical fiber, in which the coupling device of the present invention is implemented.

FIG. 2 is a schematic diagram illustrating the optical illumination pattern at the input end of the optical fiber.

FIG. 3 is a schematic diagram illustrating the optical illumination pattern at the output end of the optical fiber.

FIG. 4 is a schematic diagram illustrating the footprint of illumination on the structured reflective surfaces at the input end and the output end.

FIGS. 5A and 5B are schematic diagrams illustrating forming of a flat mirror with a spherical punch having a smooth flat surface; FIG. 5C is a photographic image of a flat mirror formed as a result.

FIG. 6 is a perspective view of the punch geometry for stamping a groove and a structured surface profile in the coupling device.

FIG. 7A is a sectional view along a longitudinal axis of the optical fiber; FIG. 7B is a perspective sectional view thereof.

FIG. 8A is a perspective view of an integrated transmitter/receiver module in accordance with one embodiment of the present invention; FIG. 8B is a perspective view of the transmitter in accordance with one embodiment of the present invention; FIG. 8C is a perspective view of the receiver in accordance with one embodiment of the present invention.

FIG. 9 is a perspective view of an active optical cable (AOC) in accordance with one embodiment of the present invention.

FIG. 10A is a further embodiment of a coupling device having an alignment mark; FIG. 10B is a further embodiment of a transmitter/receiver.

FIG. 11A schematically illustrates an assembly stand and assembling process including alignment, in accordance with one embodiment of the present invention; FIG. 11B illustrates top view of a VCSEL provided with alignment dots in accordance with one embodiment of the present invention; FIG. 11C illustrates the rotary arm of the assembly stand swung to place a transmitter on top of a coupling device, in accordance with one embodiment of the present invention.

FIG. 12 illustrates a partial perspective view of a coupling device having a plurality of structured reflective surfaces for multi-channel optical data communication, in accordance with another embodiment of the present invention.

FIG. 13A is a top perspective view of a stamped optical bench in accordance with one embodiment of the present invention; FIG. 13B is a bottom perspective view of the stamped optical bench in FIG. 13A; FIG. 13C is a top perspective view of the stamped optical bench in FIG. 13A, mounted with optical element and/or optical component; and FIG. 13D shows the sectional view taken along line 13D-13D in FIG. 13C.

FIG. 14A is a perspective view of a strip of metal for stamping of optical bench in accordance with one embodiment of the present invention; FIG. 14B is a top perspective view of the metal strip after subjecting to stamping operations to define a stamped optical bench similar to that shown in FIG. 13A, in accordance with one embodiment of the present invention.

FIG. 15A is a schematic sectional view of a structured reflective surface that is curved (e.g., aspherical), which reshapes and redirects incident light beam; FIG. 15B is a top perspective view of a stamped optical bench having a curved structured reflective surface, in accordance with another embodiment of the present invention.

### DETAILED DESCRIPTION OF THE PREFERRED EMBODIMENTS

This invention is described below in reference to various embodiments with reference to the figures. While this invention is described in terms of the best mode for achieving this invention's objectives, it will be appreciated by those skilled in the art that variations may be accomplished in view of these teachings without deviating from the spirit or scope of the invention.

The present invention provides a coupling device (e.g., a stamped optic), which may include physically and optically coupling an optical component, e.g., an input/output end of an optical fiber, for routing optical signals. The coupling device is implemented with a stamped reflective surface for routing/redirecting optical signals, and may include one or more attached or integrated structures for coupling (e.g., physically and/or optically coupling) an optical component, e.g., an optical fiber, to an optical receiver and/or transmitter, which improves manufacturability, ease of use and reliability at reduced costs, and thereby overcomes many of the drawbacks of the prior art structures.

According to the present invention, the coupling device includes a stamped structured surface on a base, which functions as an optical element that directs light to/from another optical component, e.g., to/from the input/output ends of the optical fiber, by reflection (which may also include deflection and diffraction of incident light). The coupling device forms an optical bench for supporting the optical component(s), e.g., the optical fiber. The stamped base is essentially a stamped optical bench on which optical element(s) (e.g., the structured reflective surface, and/or lenses such as ball lenses) and optical component(s) (e.g., optical fiber) are optically aligned with each other precisely. Such alignment is passive alignment, without requiring actively reading the optical signal transmitted through the components supported on the optical bench.

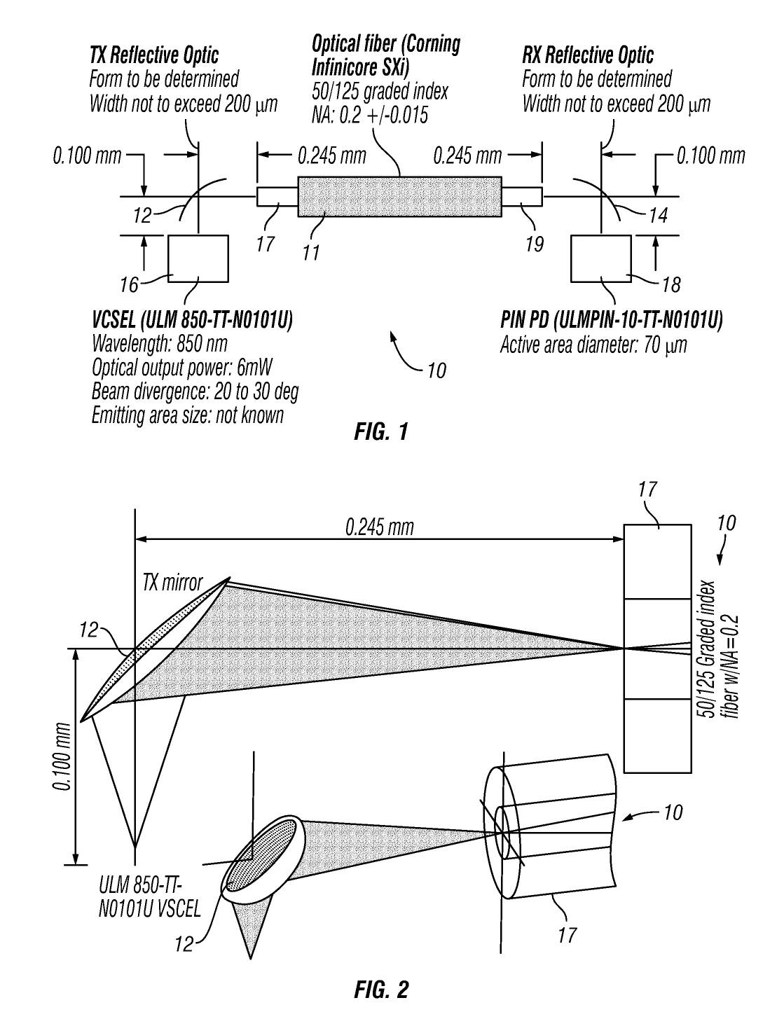

FIG. 1 schematically illustrates the configuration of data link for transmitting information over an optical fiber, in which the coupling device of the present invention is implemented. For simplicity, only some of the basic elements are included in FIG. 1 to explain the invention.

In FIG. 1, the terminating end sections of the optical fibers 10 (input end 17 and output end 19 being bare sections with cladding exposed, without protective buffer and jacket layers 11) are directed at structured reflective surfaces 12 and 14. A transmitter 16 having a light source (e.g., a laser, such as a VCSEL—Vertical Cavity Surface-Emitting Laser) converts electrical signals into optical signals. The collimated light output of the transmitter is directed at the structured reflective surface 12 of a coupling device in accordance with the present invention, which focuses light at the input end 17 of the optical fiber 10. Light signals are transmitted through the optical fiber 10, and output to the structured reflective surface 14 in another coupling device in accordance with the present invention, which focuses the output light to an optical detector (e.g., a PIN photo diode) in a receiver 18. The receiver converts optical signals into electrical signals. By appropriately modulating the electrical signal input to the transmitter 16, data is transmitted via optical signals over the optical fiber 10, and recovered as electrical signals at the receiver 18 corresponding to the input data.

In the illustrated embodiment, the optical fiber may be a 50/125 graded index optical fiber, with a numerical aperture (NA) of 0.2+/−0.015. The structured reflective surfaces 12 and 14 are configured as concave mirrors, having an aperture width not exceeding 250 μm in order to match the standard pitch between two optical fibers in a ribbon cable. The optical axis of the concave mirrors are aligned with the axis of the optical fiber 10. The ends 17 and 19 (flat or angled-polished end faces) of the optical fibers are at an effective distance (along the optical axis) of about 0.245 mm from the respective structured reflective surfaces 12 and 14. The light source in the transmitter 16 and the optical detector in the receiver 18 are at an effective distance (along the optical axis) of about 0.1 mm from the respective structured reflective surfaces 12 and 14. The optical source may be a VCSEL, having 850 nm wavelength, 6 mW optical output power, and 20 to 30 degrees beam divergence. The optical detector may be a PIN photo diode with an active area of about 70 μm diameter.

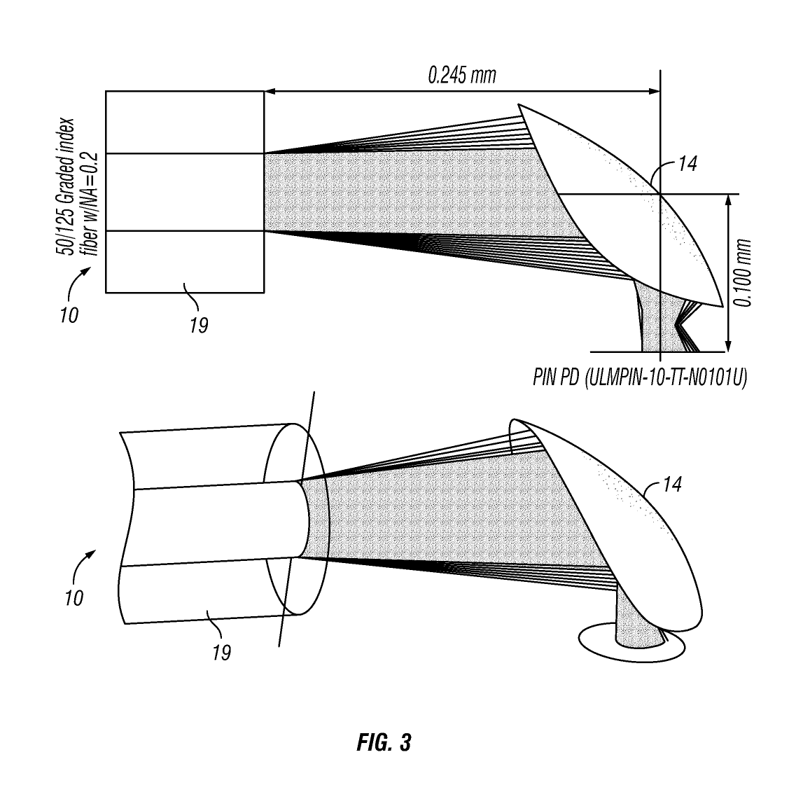

FIGS. 2 and 3 further schematically illustrate the optical illumination pattern at the respective input and output of the optical fiber 10.

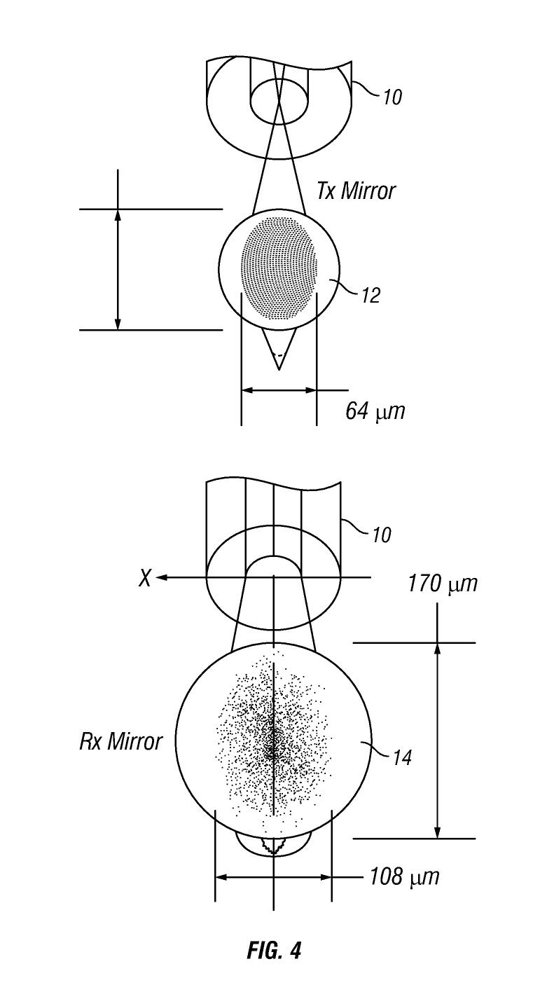

FIG. 4 schematically illustrates the footprint of illumination on the structured reflective surfaces 12 and 14. The concave mirrors defined by these reflective surfaces can have the same shape, but the size of both mirrors is set by larger spot size on the mirror at the output/receiver end. In the illustrated example, the mirrors may be 170 μm, with the spot size at the input/transmitter (Tx) end being 64 μm, and the spot size at the output/receiver (Rx) end being 108 μm.

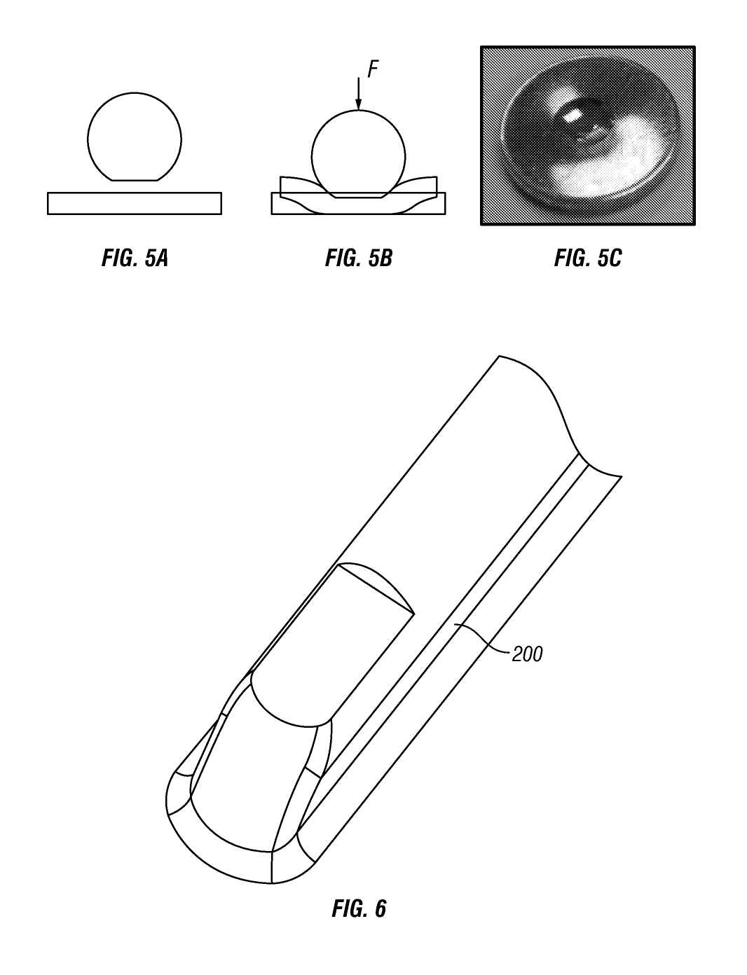

According to one aspect of the present invention, the structured reflective surface may be formed by precision stamping a metal material. FIG. 5 schematically illustrates forming a flat mirror with a spherical punch with a polished flat surface. A precision stamping process and apparatus has been disclosed in U.S. Pat. No. 7,343,770, which was commonly assigned to the assignee of the present invention. This patent is fully incorporated by reference as if fully set forth herein. The process and stamping apparatus disclosed therein may be adapted to precision stamping the features of the coupling device of the present invention (including the structured reflective surface and optical fiber retention structure disclosed below). The stamping process and system can produce parts with a tolerance of at least 1000 nm (i.e., a tolerance of 1000 nm or less/better).

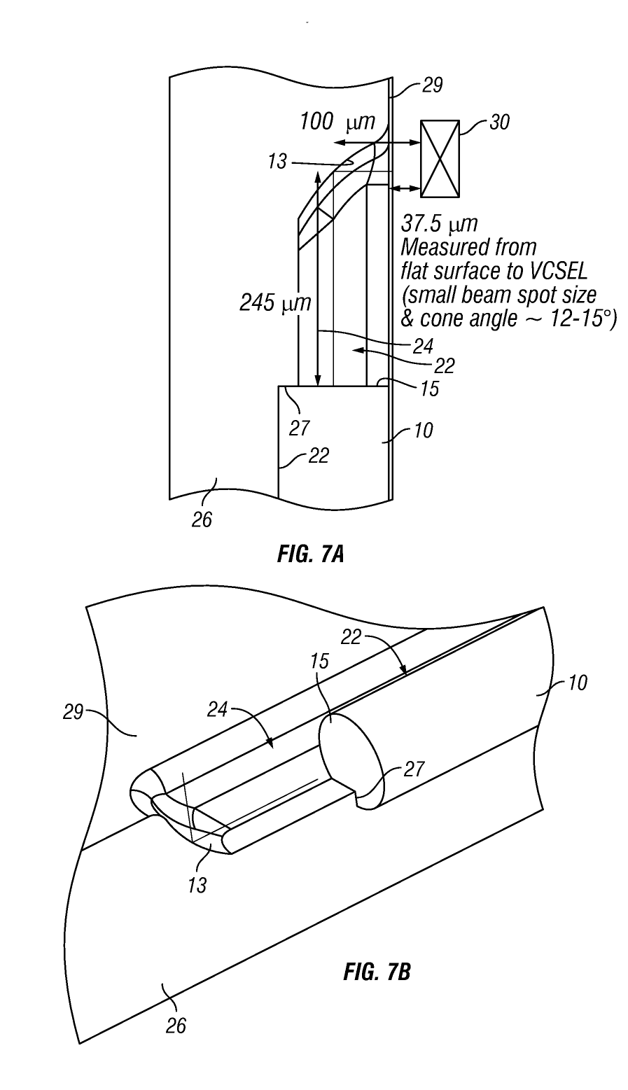

Referring to FIG. 7, in another aspect of the present invention, the coupling device includes an optical fiber retention structure, which securely and accurately aligns the optical fiber 10 with respect to the structured reflective surface 13. In a further aspect of the present invention, the structured reflective surface and fiber retention structure are defined by an open structure, which lends itself to mass production processes such as stamping, which are low cost, high throughput processes. FIG. 7A is a sectional view taken along the longitudinal axis of the optical fiber 10. FIG. 7B is a perspective section view taken along the longitudinal axis of the optical fiber 10. In the illustrated embodiment, the fiber retention structure includes a groove 22 that positively receives the optical fiber in a manner with the end of the optical fiber 10 at a defined distance to and aligned with the structured reflective surface 13. The location and orientation of the structured reflective surface 13 is fixed in relation to the fiber retention structure. In the illustrated embodiment, the fiber retention structure and the structured reflective surface are defined on the same (e.g., monolithic or unitary) base 26 of the coupling device. In an alternate embodiment (not illustrated), the fiber retention structure and the structure reflective surface are defined on separate structures that are coupled together to form the coupling device. The groove 22 has a section 24 defining a space between the end face 15 of the optical fiber 10. In the illustrated embodiment, this section 24 has a similar width but a shallower bottom as the remaining sections of the groove 22. The section 24 defines a shoulder 27 that provides a stop against which a portion (end) of the end face 15 of the optical fiber 10 is butted. Accordingly, a distance (e.g., 245 μm) along the optical axis is defined between the end face 15 and the structured reflective surface 13. In the illustrated embodiment, the optical fiber is completely received in the groove 22, with the exterior surface of the optical fiber 10 flush with the top surface 29 of the base 26. Given an optical fiber having a diameter of 125 μm, and a VCSEL light source 30 at an effective distance (e.g., from the flat surface of the VCSEL 30 along the optical axis) of 100 μm from the structured reflective surface 13, the distance of the flat surface of the VCSEL from the top surface 29 of the base 26 would be about 37.5 μm.

The groove 22 is structured to securely retain the fiber 10 (bare section with cladding exposed, without protective buffer and jacket layers) by clamping the fiber 10, e.g., by a mechanical or interference fit (or press fit). The interference fit assures that the fiber 10 is clamped in place and consequently the position and orientation of the fiber 10 is set by the location and longitudinal axis of the groove 22. In the illustrated embodiment, the groove 22 has a U-shaped cross-section that snuggly receive the bare optical fiber 10 (i.e., with the cladding exposed, without the buffer and protective layers). The sidewalls of the groove 22 are substantially parallel, wherein the opening of the groove may be slightly narrower than the parallel spacing between the sidewalls (i.e., with a slight C-shaped cross-section) to provide additional mechanical or interference fit for the fiber 10. Further details of the open groove structure can be found in copending U.S. patent application Ser. No. 13/440,970 filed on Apr. 5, 2012, which is fully incorporated by reference herein. The base 26 having the groove 22 is effectively a one-piece open ferrule supporting the optical fiber 10 in precise location and alignment with the structured reflective surface 13. The location of the structured reflective surface 13 is fixed with respect to the groove 22 and the shoulder 27, and hence fixed with respect to the end face of the optical fiber 10. The structured reflective surface 13 is not supported on a moving part and does not involve any moving part.

In one embodiment, the base 26 of the coupling device is formed of a metal material. In one embodiment, the metal material may be chosen to have high stiffness (e.g., stainless steel), chemical inertness (e.g., titanium), high temperature stability (nickel alloy), low thermal expansion (e.g., Invar), or to match thermal expansion to other materials (e.g., Kovar for matching glass). For reflectivity, the base 26 may be formed of a metal such as aluminum or copper, which offer higher optical reflectivity. The reflectivity can also be achieved by plating materials such as gold, silver, nickel, aluminum, etc. onto the body 26. Alternatively, the material may be a hard plastic or other hard polymeric material. The above disclosed open structure of the coupling device having the structured reflective surface and the fiber retention structure lends itself to mass production processes such as stamping, which are low cost, high throughput processes. A precision stamping process and apparatus has been disclosed in U.S. Pat. No. 7,343,770, which was commonly assigned to the assignee of the present invention. This patent is fully incorporated by reference as if fully set forth herein. The process and stamping apparatus disclosed therein may be adapted to precision stamping the base of the present invention.

FIG. 6 illustrates a punch 200 configured for stamping the groove 22 and structured reflective surface 13 in the base 26. The punch 200 has a convex surface profile that is essentially the inverse of the structured reflective surface and the groove. The surface profile of the punch 200 conforms to the features to be stamped.

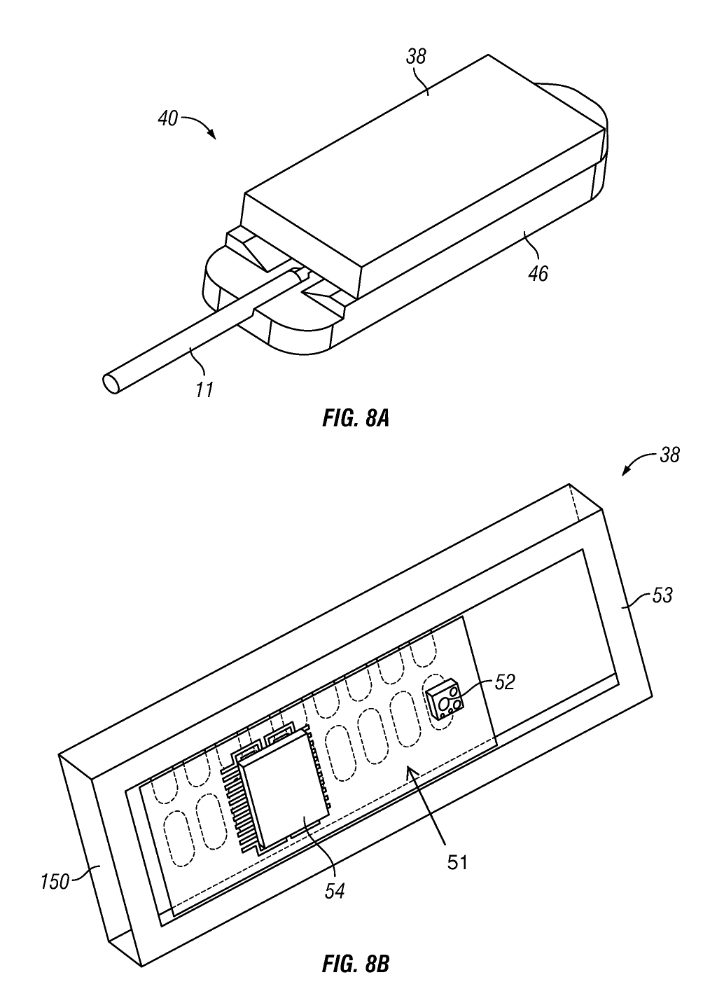

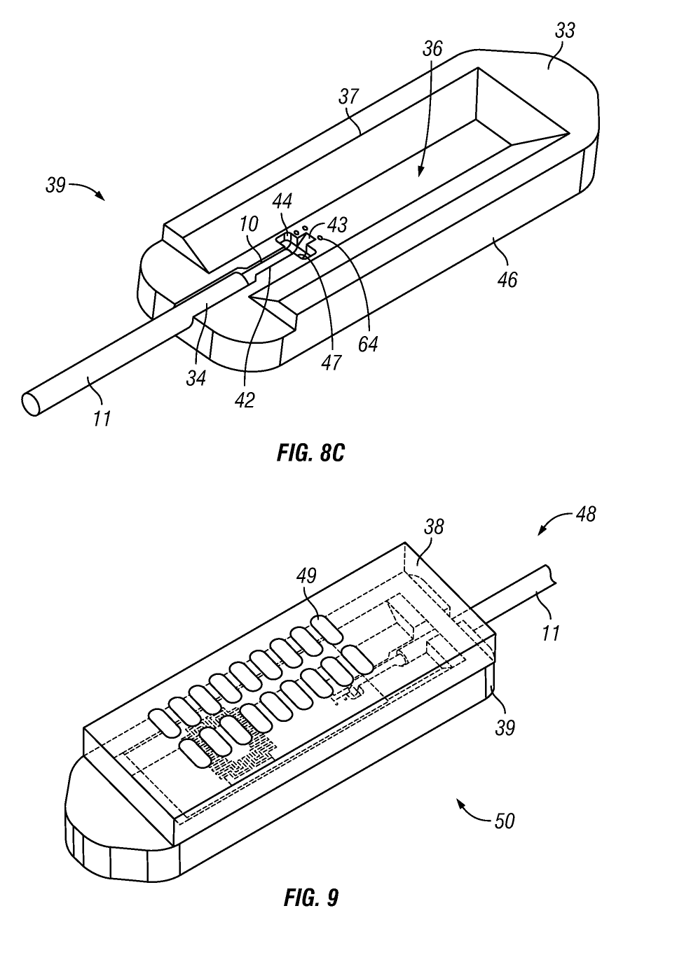

FIG. 8A illustrates an embodiment of an integrated transmitter/receiver module 40 comprising a transmitter/receiver 38 attached to an optical coupling device 39, with the structured reflective surface in the coupling device aligned to the light source/detector in the transmitter/receiver. FIG. 8B illustrates an embodiment of a transmitter/receiver 38. The transmitter/receiver 38 includes a base 150 supporting a circuit board 51, on which a light source/detector 52 (e.g., a VCSEL/a photodiode) and associated control circuit 54 (e.g., an IC chip) are mounted. A bonding surface 53 is defined at the perimeter of the transmitter/receiver 38.

FIG. 8C illustrates the internal open structure of the coupling device 39, which is quite similar to the open structure of the coupling device discussed above. Essentially, the coupling device 39 has a base 46 having a groove 42 and structured reflective surface 43 defined therein similar to the groove 22 and structured reflective surface 13 defined in base 26 in the earlier embodiment of FIGS. 6 and 7 discussed above. In this embodiment, the section 44 of the groove 22 is wider, but nonetheless has a depth defining a shoulder 47 to precisely position the end face of the fiber 10. A wider groove 34 is provided on the base 46 to receive the thicker section of the fiber having the protective layer 11. Epoxy may be applied to secure the protective layer 11 in the groove 34.

In this embodiment, the base 46 has raised sidewalls 37 defining a cavity 36 in which the structured reflective surface 43 and grooves are located. The cavity 36 provides space for accommodating the height of the IC chip mounted on the circuit board 51. The height of the sidewalls 37 defines the distance between the light source/detector in the transmitter/receiver 38 and the structured reflective surface 43 in the coupling device 39. Referring also to FIG. 7A, given an optical fiber having a diameter of 125 μm, and the flat output surface of the VCSEL along the optical axis of 100 μm from the structured reflective surface 43, the height of the sidewalls 37 defines the distance of the flat output surface of the VCSEL from the surface of the cavity 36 (corresponding to the top surface 29 of the base 26 in FIG. 7A) to be about 37.5 μm.

As one can appreciate, in the module 40, given the fixed structured reflective surface and the fiber retention structure are precisely defined on the same coupling device, by aligning the light source in the transmitter or the light detector in the receiver to the structured reflective surface in the coupling device, the light source/detector would be precisely aligned to the input/output end of the optical fiber.

From another perspective, the above described combination of transmitter/receiver and coupling device may be perceived to be an integrated transmitter/receiver module that includes a structured reflective surface and an integral coupling structure that aligns an optical fiber to the structured reflective surface.

The coupling device 39 may be stamped from a malleable metal material, as discussed earlier. The top surface 33 of the sidewalls 37 provides a bonding area for attaching to the transmitter/receiver 38. The transmitter/receiver 38 may be attached to the coupling device 39 by glue, epoxy, solder or welding. In one embodiment, the transmitter/receiver 38 may be hermetically sealed against the coupling device 39, for example, by laser welding, soldering, or blazing. The transmitter/receiver 38 and the coupling device can be manufactured and tested separately prior to assembly.

In another aspect of the present invention, an optical fiber is structured as an active optical cable (AOC), which is a cable known in the art to have a transmitter at one terminal end of the optical fiber for electrical-to-optical conversion, and a receiver at another terminal end of the optical fiber for optical-to-electrical conversion. FIG. 9 illustrates an embodiment of an AOC 48 that adopts the transmitter/receiver module 50 in accordance with the present invention. (Only one end of the AOC is shown in FIG. 9; the other end is similar in structure, wherein one end is a transmitter module having a laser or light source and another end is a receiver module having a photonic detector.) The structure of the module 50 is similar to the structure of the module 40 in the earlier embodiment of FIG. 8, with the exception of electrical contact pads 49 provided on the outside of the transmitter/receiver 38. The electrical contact pads 49 provide external electrical access to the control circuit 54 inside the module 50.

Referring also to the schematic drawing of FIG. 1, the AOC 48 essentially includes the components illustrated in FIG. 1. The AOC 48 includes an optical fiber (bare fiber 10 and protective layers), a transmitter module 50 corresponding to the combination of transmitter 16 and a coupling device having the structured reflective surface 12 and a fiber retention structure discussed above which supports the end 17 of the fiber 10, a receiver module 50 corresponding to the combination of receiver 18 and a coupling device having the structured reflective surface 14 and a fiber retention structure discussed above which supports the end 19 of the fiber 10.

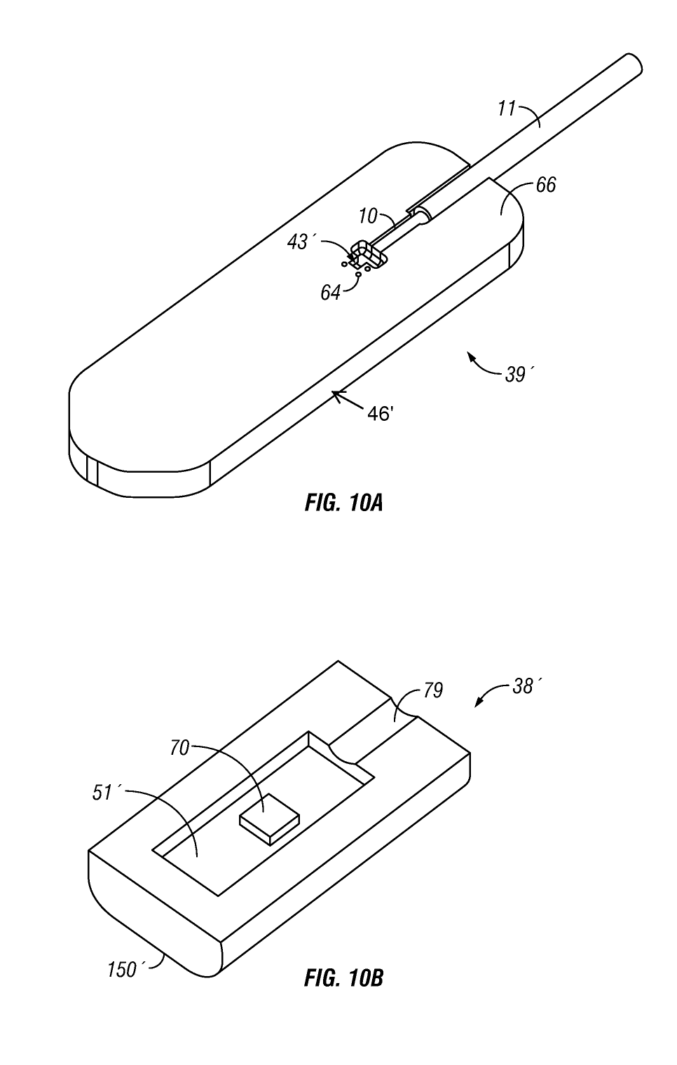

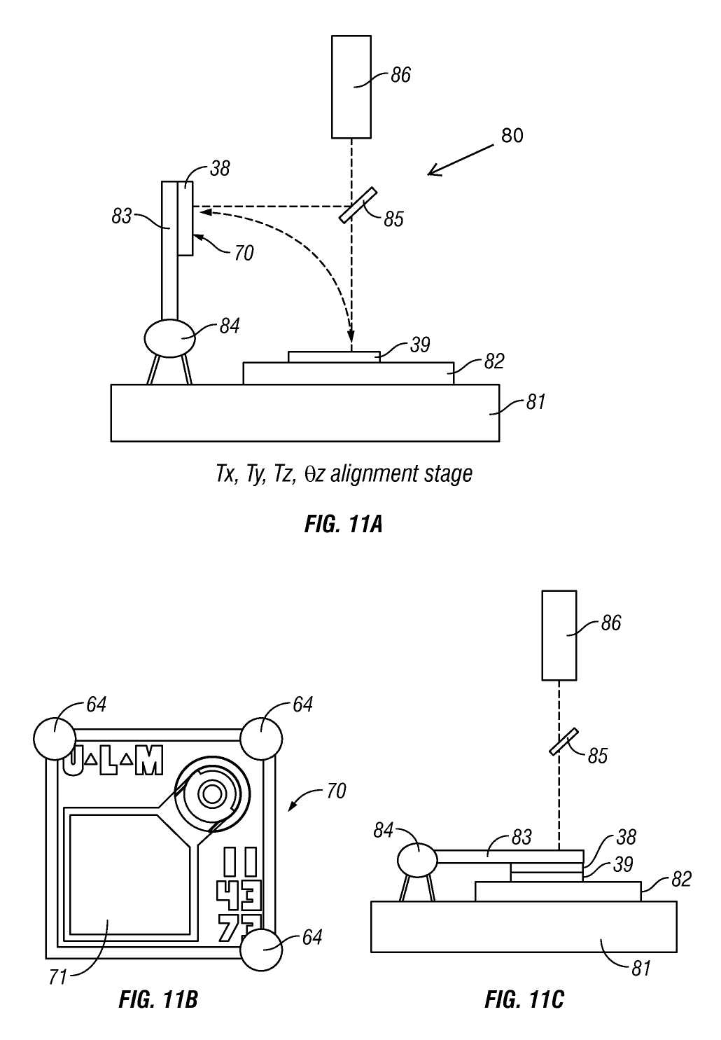

FIGS. 10 and 11 illustrates an embodiment of an assembling process, including precise alignment of the transmitter/receiver to the coupling device by superimposing complementary alignment marks provided on the transmitter/receiver and the coupling device. FIG. 10A is another embodiment of a coupling device 39′ which is similar to FIG. 8C, except omitting raised sidewalls of the coupling device. An alignment groove is provided on the top surface of the base 46′ of the optical coupling 39′. The base 46′ precisely aligns the optical fiber 10 held in a groove, with respect to the structured reflective surface 43′. The alignment mark comprises three dots 64 (which may be dimples produced by the stamping process forming the groove and structured reflective surface) arranged in an L-configuration around the structured reflective surface 43′, thus providing spatial alignment in two axis/directions. The alignment dots 64 are spaced so that they correspond to certain features on the light source/detector on the transmitter/receiver. For example, FIG. 11B represents the top view of the square top surface 72 of a VCSEL 70. The VCSEL 70 has an output area 71 that is offset closer to one corner of the square top surface 72. Accordingly, by placing the three dots 64 on the top surface 66 adjacent to two sides of the structured reflective surface 43′, and further with the dots 64 spaced to correspond to the corners of the square top surface 72 of the VCSEL 70, the output area 71 can be aligned to the structured reflective surface 43′ by aligning the dots 64 to the corners of the square top surface 72 of the VCSEL 70. Similar alignment of the photo diode in a receiver to a structured reflective surface defined on a coupling device, by providing similar alignment marks on the top surface of the coupling device in a similar manner as discussed above. Referring back to FIG. 8C, similar alignment mark (dots 64) is provided on the bottom of the cavity around the structured reflective surface 43.

FIG. 10 illustrates another embodiment of the transmitter 38′. The base 150′ has raised sidewalls having a groove relief 79 to accommodate the extra thickness of the protective layer 11 of the optical fiber 10. The VCSEL 70 is mounted on a circuit board 51′.

FIG. 11A schematically illustrates an assembly stand 80 including an alignment system that adopts the above described alignment marks. The assembly stand 80 includes a base 81 supporting an alignment stage 82 (e.g., X-Y translations in the X-Y horizontal plane and orthogonal Z-axis out of plane, and rotation about the Z-axis). The assembly stand 80 further includes a rotary arm 83 having a pick-and-place head, which is supported to rotate about a bearing 84 to swing the arm onto over the alignment stage 82. The coupling device 39′ (or the coupling device 39 in FIGS. 8 and 9) is supported on the alignment stage 82, with the alignment dots 64 in a horizontal plane. The transmitter/receiver 38′ (or the transmitter/receiver 38 in FIGS. 8 and 9) is support by the pick-and-place head of the rotary arm 83. With the rotary arm 83 in a vertical position as shown in FIG. 11A, the square top surface 72 of the VCSEL 70 is in a vertical plane. The axis orthogonal to the plane of the square top surface 72 of the VCSEL 70 is orthogonal to the axis orthogonal to the plane of the alignment dots 64. Using a camera 86 and a beam splitter 85 provides for simultaneous imaging of both the square top surface 72 of the VCSEL 70 and the alignment dots 64. By actuating the alignment stage 82, the image of the alignment dots 64 can be brought into alignment with the image of the square top surface 72, as shown in FIG. 11B. The rotary arm 83 is then swung to place the transmitter 38′ on top of the coupling device 39′, as shown in FIG. 11C. The transmitter 38′ and the coupling device 39′ are joined by, for example, laser welding, laser assisted soldering, or infrared soldering.

The coupling device in accordance with the present invention overcomes many of the deficiencies of the prior art, which provides ease of use and high reliability with low environmental sensitivity, and which can be fabricated at low cost. The inventive coupling device may be configured to support a single or multiple fibers, for optical input, optical output or both (for bi-direction data communication).

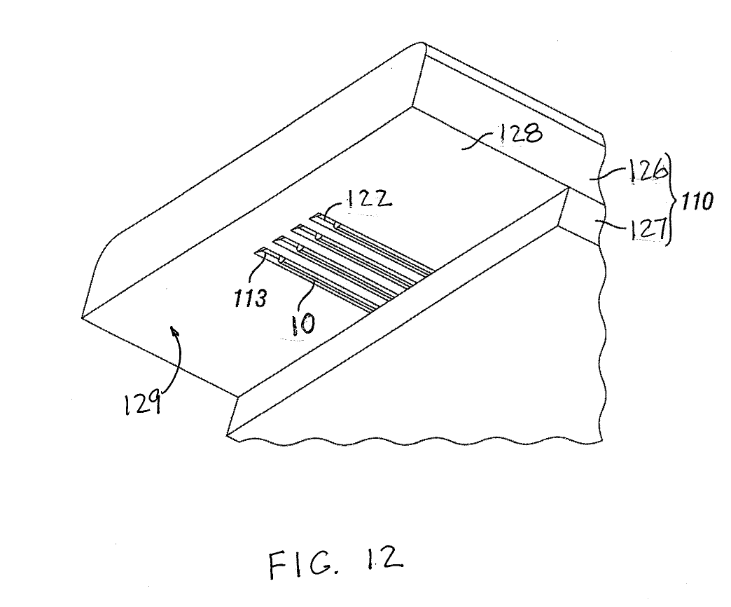

While the embodiments above are described in reference to a coupling device for a single optical fiber, it is well within the scope and spirit of the present invention to adapt the above disclosed coupling device structures for multiple optical fibers by providing parallel grooves in the coupling device, such as in the coupling device disclosed in parent U.S. patent application Ser. No. 13/861,273 filed on Apr. 11, 2013 (which had been incorporated by reference herein). It discloses a coupling device in the form of a hermetic optical fiber alignment assembly having integrated optical element. Referring to FIG. 12 herein, in one of the disclosed embodiments in the parent application, the hermetic optical fiber alignment assembly 110 includes a base 126 and a cover 127. The base 126 includes a plurality of grooves 122 (which can be similar to the grooves 22 disclosed in the embodiment above), each having a stamped structured reflective surface 113 at the end of each groove 122. As in the case of the single groove embodiment described above, the structured reflective surfaces 113 and the alignment grooves 122 may be formed integrally by precision stamping a base out of a metal stock material. The optical fibers 10 are retained in the grooves 122 in relation to the structured reflective surfaces, with the end of each optical fiber 10 at a defined distance to and aligned with the corresponding structured reflective surface 113. The exterior of the optical fiber 10 is flush with or below the top surface 129 of the base 126. The base 126 has a portion 128 that extends beyond the adjacent end of the cover 127. As illustrated, the base 126 is provided with fiber alignment grooves 122 that extend beyond the edge of the cover 127 to the extended portion 128. Each groove 122 terminates in a structured reflective surface 113 located beyond the adjacent edge of the cover 127. Each optical fiber 10 extends in the groove 134 to beyond the edge of the cover 127, to closer to the structured reflective surface 113. Each of the channel defined by a groove 122 is associated with an external optical component, such as light source and/or a light receiver (not shown), similar to the configuration shown in FIG. 7A.

For all the above described embodiments, from another perspective, the combination of transmitter/receiver and coupling device may be instead perceived to be an integrated transmitter/receiver module that includes one or more light sources/detectors, an integral coupling structure that includes one or more structured reflective surfaces and aligns one or more optical fibers to the structured reflective surfaces.

Further, in the above described embodiments, the optical fiber is an example of an optical component that can be supported by the base (more specifically retained in integrally formed stamped grooves in the base) in alignment with the stamped structured surface in the coupling device, and the structured reflective device is an example of a structured surface. The corresponding alignment structure on the base comprises features defining a groove that is integrally formed by with the structured reflective surface by stamping a metal stock material (e.g., in the form of a blank, or a strip). Other types of optical components, such as ball lenses, optoelectronic devices (e.g., a light source such as a VCSEL, a photosensor such as a photodiode), etc., can be supported in integrally stamped alignment structures, e.g., features such as grooves (including slots) for optically aligning optical fibers with the stamped structured reflective surface. Accordingly, the stamped base supports the inventive concept of a stamped optical bench on which optical element(s) (i.e., the structured reflective surface) and optical component(s) (e.g., optical fiber) are optically aligned with each other precisely. Such optical alignment involves passive alignment, without requiring actively reading an optical signal transmitted through the components supported on the optical bench.

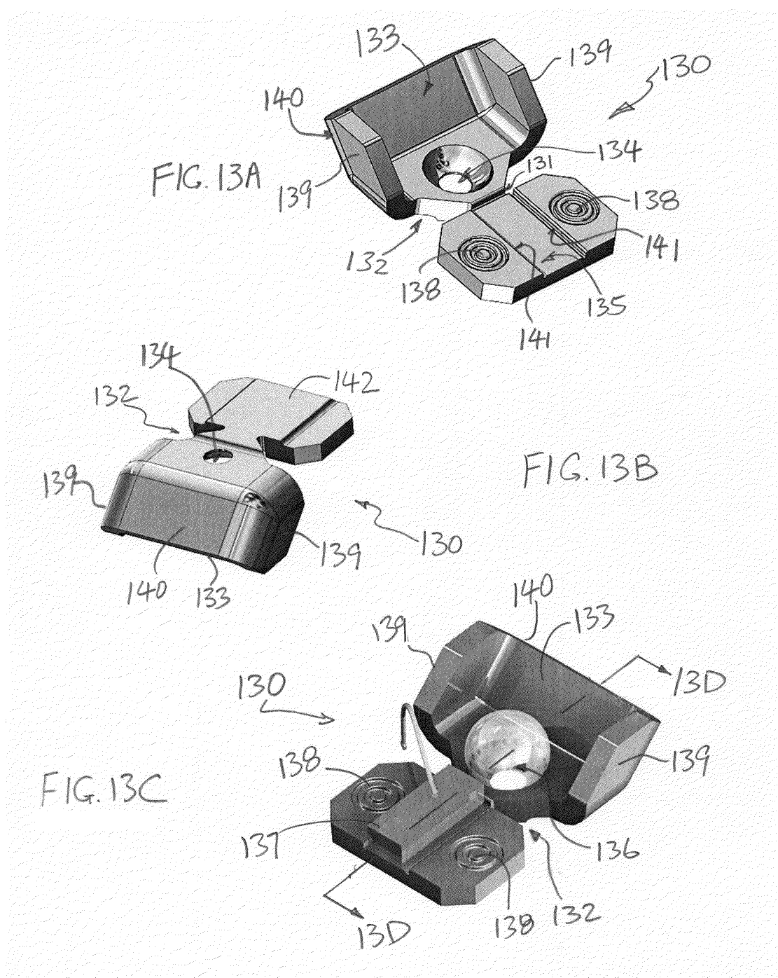

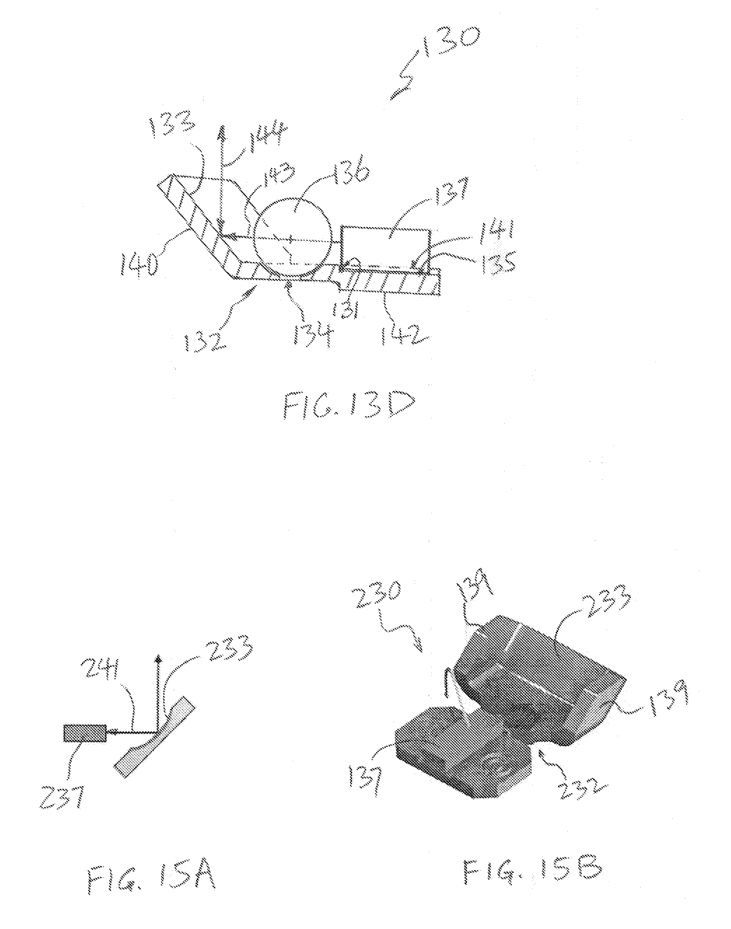

In a further aspect of the present invention, silicon optical benches having particular defined optical paths through various optical elements and components, such as those disclosed in the patents discussed in the Background section herein, can be replaced by a stamped optical bench in accordance with the present invention. To illustrate the inventive concept, FIGS. 13A-13D are illustrative of a stamped optical bench that can replace a silicon optical bench that supports generally a light source/sensor, a ball lens for collimating diverging incident light, and a reflective mirror.

Specifically, FIG. 13A is a top perspective view of a stamped optical bench 130 in accordance with one embodiment of the present invention, and FIG. 13B is a bottom perspective view of the optical bench 130. As will be further described below, the optical bench 130 is formed by stamping a stock material (e.g., in the form of a blank, or a strip), as was the case with the earlier described embodiments. As was in the case of the earlier described embodiments, the optical bench 130 includes a base 132 having a structured reflective surface 133, and surface features to facilitate registration and accurate passive alignment of optical components with respect to each other and to the structured reflective surface 133.

In this embodiment, the passive alignment structures including features such as an axisymmetrical seat 134 for seating a ball lens 136 and a slot 135 for seating an optical component 137, such as an optoelectronic device (e.g., a light source, such as laser diode or a VSCEL and/or a light sensor, such as a photodiode), as shown in FIG. 13C. FIG. 13D shows the sectional view taken along line 13D-13D in FIG. 13C. The seat 134 may be a through-hole with or without a chamfer, a countersink having a conical surface, or, as illustrated, a countersink having a spherical surface profile to match the spherical ball lens 136. The seat 134 may take on other configurations (e.g., a raised 3-point stand) to positive register the ball lens 136 in an aligned manner on the base 132.

The slot 135 has at least one step/shoulder 141 for referencing placement of the optical component 137 on the base 132. Another step/shoulder 131 may be provided to define a stop for abutting the end of the optical component 137, so as to define and/or limit the distance between the optical component 137 and the ball lens 136. One or more visual alignment marks (also known in the art as “fiducials” or “fiduciary marks”) are provided on the base 132, to provide an optical reference to facilitate accurately positioning the optical axis of the optical component 137 (e.g., the axis of the output light beam in the case of a light source such as a VSCEL, or the light receiving axis of the sensor in the case of the light sensor; see optical path 143 shown in FIG. 13D) in relationship to the ball lens 136 and/or structured reflective surface 133. There would be alignment marks (not shown) provided on the body of the optical component 137, identifying its optical axis in reference to such alignment marks on its body. The relative position of the alignment marks 138 and the alignment marks on the body of the optical component 137 would facilitate optical alignment of the optical component 137 with respect to the ball lens 136 and/or structure reflective surface 133. If the optical component 137 has an external geometry that is precisely defined with respect to its optical axis, then the optical component 137 may be aligned by registering the optical component 137 against shoulder 141 and shoulder 131 provided on the base 132.

As shown in FIG. 13C, the structured reflective surface 133 is defined at an extended portion 140 of the base 132, which is generally inclined with respect to a plane of the rest of the base 132 at which the seat 134 and the slot 135 are defined. In this embodiment, the surface of the structured reflective surface 133 is flat, defining a flat mirror surface inclined at 45° to the optical path 143. In order for the optical path 143 and optical path 144 at the structured reflective surface 133 to be precisely maintained, the extended portion 140 must be maintained at a predefined angle that would not vary appreciably. Webs or gussets 139 are provided at the side of the extended portion 140 to stiffen and secure the extended portion 140, and maintain the inclination angle of the extended portion 140 (and hence the structured reflective surface 133) with respect to the seat 134 (and hence the ball lens 136) and the slot 135 (and hence the optical axis of the optical component 137) during and after stamping operations. The gussets 139 could be generally formed along with the extended portion 140 from the same metal stock material.

Referring also to FIG. 13B, the stamped optical bench 130 includes rounded edges to reduce stress in the punch and die during stamping operations (e.g., rounded edges between the gussets 139 and the extended portion 140. A pad 142 having a flat surface is provided for attachment to an external substrate (not shown). The perimeter of the portion of the base 132 around the pad 142 is provided with rounded corners/edges to facilitate stamping operations.

For the optical bench illustrated in FIG. 13D, in the case the optical component 137 is a light source such as a VSCEL (found in a transmitter Tx), it outputs a diverging light beam along path 143, which is reshaped (e.g., collimated) by the ball lens 136, before being turned/reflected by the structured reflective surface 133, to path 144. This output beam can be directed to an optical fiber (not shown) to be transmitted to a desired end point. In the case of a flat reflective surface defined on the extended portion 140, the reflective light beam path 144 is essentially turned 90° with respect to the incident beam path 143. In the case the optical component 137 is a light sensor such as a photodiode (found in a receiver Rx), incident light along path 144 (e.g., from an optical fiber (not shown)) is directed at the structured reflective surface 133, turned 90° to path 143, passes through the ball lens 136, and converges at the optical component 137 (photodiode). In the case the optical component 137 contains both light source and sensor (e.g., found in a transceiver Tx/Rx), for the light source, it outputs a diverging light beam along path 143, which is reshaped (e.g., collimated) by the ball lens 136, before being turned/reflected by the structured reflective surface 133, to path 144. This output beam can be directed to an optical fiber (not shown) to be transmitted to a desired end point. In the case of a flat reflective surface defined on the extended portion 140, the reflective light beam path 144 is essentially turned 90° with respect to the incident beam path 143. In the case the optical component 137 contains both light source and sensor (e.g., found in a transceiver Tx/Rx), for the sensor, incident light along path 144 (e.g., from an optical fiber (not shown)) is directed at the structured reflective surface 133, turned 90° to path 143, passes through the ball lens 136, and converges at the optical component 137 (Tx/Rx).

As was in the case of the earlier described embodiments, the above described surface features of the base 132 are integrally stamped from the same metal stock material. Matching punches and dies having appropriate features defined thereon are applied in a series stamping operations to obtain the desired geometries of the above-described features of the optical bench 130. Preferably, at least the features critical to precise optical alignment are subject to a final stamping operation, by which such features are finally defined on the same (e.g., monolithic or unitary) base 132. For the illustrated embodiment, this would include at least the structured reflective surface 133, the seat 134 and the alignment marks 138, and further the gussets 139, the slot 135 (if the shoulders 131 and 141 are required for optical alignment), and the flat surface of the pad 142. These features may be individually preformed during a sequence of stamping operations, but they are subject to a final stamping operation using a stamping punch that integrally defines the final geometry of the combination of these features in relationship to each other on the same (monolithic or unitary) base 132. A final set of punch and die is applied to produce the desired final geometries that would define the optical path and optical alignment structures (e.g., features such as lens seat, registration shoulders, alignment marks) provided by the optical bench 130. This is akin to using the punch 200 in the earlier described embodiment of FIG. 6, to define the final geometries of the alignment structures (i.e., features including groove 22) and structured reflective surface 13 shown in FIGS. 7A and 7B, in relationship to each other.

For example, the following separate stamping operations may be applied to preform the following features in preparation for the final features: a through-hole is punch out from the metal stock material to prepare for forming the seat 134; a wall is preshaped from the metal stock material to prepare for the extended portion 140 and gussets 139; and a pilot slot is preformed to prepare for the slot 135. A subsequent single stamping operation forms the final geometries of the seat 134, slot 135, and the extended portion 140 and gussets 139.

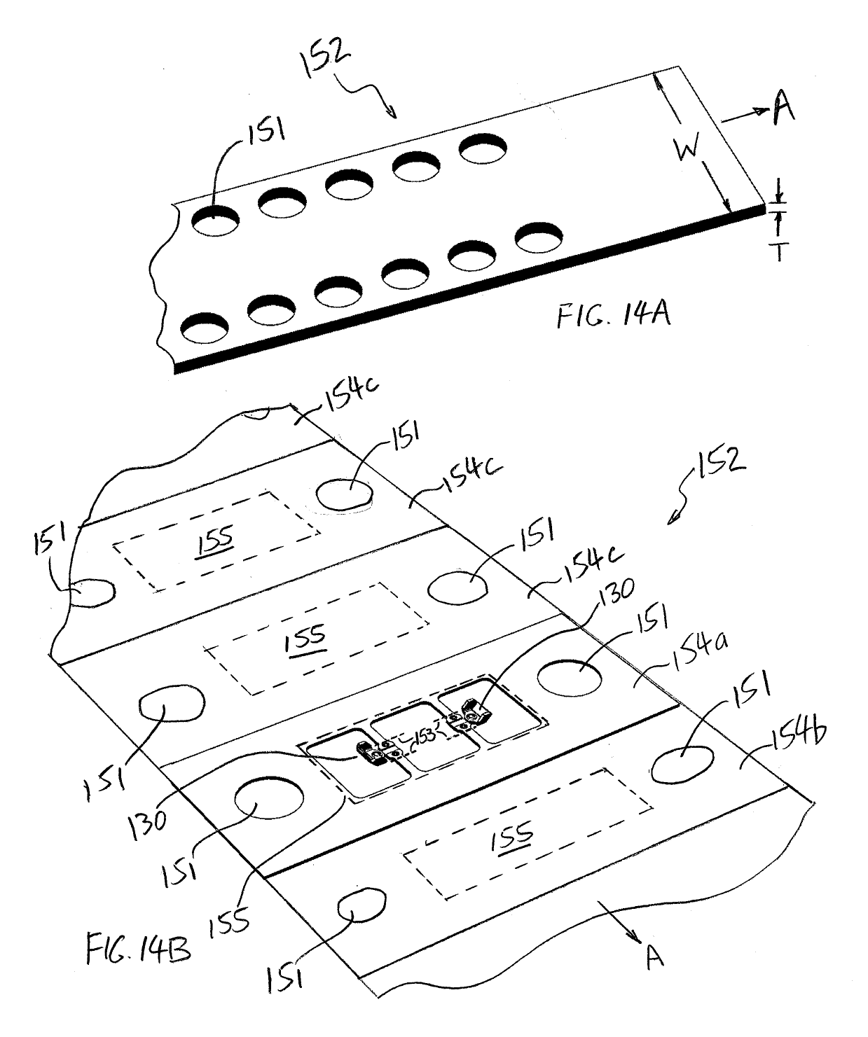

FIGS. 14A and 14B schematically illustrate the stamping operations on a metal stock material. Referring to the embodiment of FIG. 14A, the metal stock material is in the form of a longitudinal flat ribbon or strip 152 of metal (equivalent to a series of connected blanks), having a chosen width W (e.g., 10 mm) and a chosen thickness T (e.g., 0.5 mm) that would provide the desired thickness of the base 132 in the optical bench 130 of the embodiment of FIGS. 13A-13D. The material of the strip 152 may be chosen to have high stiffness (e.g., stainless steel), chemical inertness (e.g., titanium), high temperature stability (nickel alloy), low thermal expansion (e.g., Invar), or to match thermal expansion to other materials (e.g., Kovar for matching glass).

The strip 152 has a series of indexing holes 151 formed along its opposing longitudinal edges, as shown in FIG. 14A. The strip 152 is fed through a series of stamping stations, subject to precision stamping operations to form the desired features. The indexing holes 151 are used for indexing the strip 152 as it is fed through the stamping stations. The entire strip 152 may be progressively fed through a first stamping station before the entire strip 152 is progressively fed through a second stamping station, and so forth. Alternatively, the strip 152 may be fed continuously through a series of progressive stamping stations. As noted above, the features on the optical benches 132 in the coupling devices 130 may be progressively formed via a sequence of stamping operations, with the final geometry of the features being defined by a single stamping operation in the sequence to define the final geometry of the surface features of the coupling devices.

As earlier noted in connection with the earlier embodiments, the precision stamping process and apparatus has disclosed in U.S. Pat. No. 7,343,770 (which was commonly assigned to the assignee of the present invention) could be adopted to stamp strip 152 to form the features of the coupling devices of the present invention (including the structured reflective surface and alignment structures having features discussed above). The stamping process and system can produce parts with a tolerance of at least 1000 nm (i.e., a tolerance of 1000 nm or less/better). This patent is fully incorporated by reference as if fully set forth herein.

FIG. 14B schematically illustrates a section of the strip 152 after it had been subject to stamping operations. A plurality of stamped sections 154 are defined along the strip 152. For the sake of simplicity, in the illustrated embodiment of FIG. 14B, each stamped section 154 corresponds with indexing holes 151 (in other words, the pitch of adjacent indexing holes 151 is the same as the width D of a section 154 (e.g., 4 mm)). For purpose of illustration, the strip 152 is used to form the coupling devices 130 described in connection with FIGS. 13A-13D above. Specifically as illustrated, at each section 154, two coupling devices 130 are being formed by stamping. The region 155 between opposing indexing holes 151 in each section 154 represents the region at which parts are stamped to form the coupling devices disclosed above is located. In FIG. 14B, other than in section 154a, the region 155 in the other sections 154 are schematically represented by dotted lines.

Arrow A represents the direction of feed of the strip 152. Section 154a represents a “finished” stamped section at which the features of the coupling devices 130 have been finally formed by stamping. Given the direction of feed (arrow A), the sections 154b are also “finished” stamped sections that were subject to earlier stamping operations. Sections 154c are sections to be finally stamped to finish forming the coupling devices 130.

As shown in FIG. 14B, within each region 155, two identical coupling devices 130 are simultaneously formed by stamping operations, wherein the two devices 155 are mirror images of each other about the central axis of the strip 152. This “two-up” configuration achieves certain advantages, namely it provides force symmetry along the central axis of the strip 152, thereby providing stability during stamping operations of the opposing coupling devices 130, which improves the integrity and precision of the stamping operations.

Based on prior experimental results, it has been found that stamped structured reflective surfaces can achieve a peak-to-valley form error of less than 1 μm over a 1 mm diameter area. Surface roughness (Ra) based on scanning white light interferometry is on the order of 8 nm or better. The compression of the malleable material between the punch and die generates high contact pressure for a high reflective, mirror-quality surface.

It is noted that the optical benches 130 are separated (e.g., by cutting along dotted lines 153) from the regions 155 in strip 152, which may be subject to further processing (e.g., surface finishing and/or coating, such as gold plating to improve reflectivity, anti-corrosion, etc.) Alternatively, the optical benches 130 may be subject to further processing prior to separating from the strip 152. Further, the ball lens 136 and other optical components may be mounted while the optical benches 130 are still attached to strip or after cutting from the strip 152.

The above-described embodiment is illustrative of how a basic combination of features and components (i.e., a ball lens, a mirror, an optoelectronic device (e.g., a light source and/or sensor) defined on a silicon optical bench can be transformed to corresponding features defined on a stamped optical bench, achieving a similar defined optical path with optical alignment at tight tolerances. Other configurations of prior art silicon optical benches may be re-configured with stamped optical benches having similar defined optical paths. A stamped optical bench could have similar overall size and configuration, and similar footprint, compared to a corresponding silicon optical bench. The stamped optical bench would be backward compatible to replace a silicon optical bench. It is conceivable that stamped optical benches could be configured to have a smaller footprint and overall size than silicon optical benches.

A stamped optical bench can effectively simplify the configuration of a silicon optical bench, without compromising the desired defined optical path. Depending on the geometry of the structured reflective surface, light can be redirected, and further may be reshaped (e.g., collimated, focused, diverged, diffracted, etc.), without requiring use of an optical element such as a lens (e.g., a ball lens). For example, the structured reflective surface may have a surface profile that focuses or collimates light in addition to redirecting (e.g., turning) light.

In reference to the embodiment illustrated by FIGS. 13A-13D, the ball lens may be omitted by adopting a stamped reflective surface having a curvature that substitutes for the optical function as the ball lens. This lowers the cost of by removing an assembled component from the optical bench without compromising functionality of the optical bench, thereby simplifying the structure of the optical bench, and reducing a potential source of error arising from potential optical misalignment of the ball lens. As was the case with the earlier described embodiment of FIGS. 7A and 7B, a ball lens is not required to reshape (e.g., collimate) incident light.

The curved structured reflective surface serves the functions of both a reflective surface (i.e., redirecting incident light) and an optical element (i.e., reshaping incident light). It may have a reflective surface profile conforming to an optical element such as ball lens, spherical lens, plano-convex lens, concave lens, or a combination thereof. As a result, the structured reflective surface of the present invention permits more options for reshaping light beam as compared to a ball lens.

In accordance with another embodiment of the present invention, FIG. 15A schematically illustrates a structured reflective surface 233 that is concave, which can reshape and redirect an incident light beam 241 to/from an optoelectronic device 237 (e.g., a light sensor/source). For example, the structured reflective surface 233 may have a concave aspherical reflective surface profile, which serves both functions of reflecting and reshaping (e.g., collimating or focusing) a diverging incident light, without requiring a lens as was in the case of the embodiment in FIGS. 13A-D. FIG. 15B is a top perspective view of a stamped optical bench 230 having the concave structured reflective surface 233. The structure of the stamped optical bench 230 is generally similar to that of the stamped optical bench 130, except that the stamped optical bench 230 does not include a ball lens given the concave structured reflective surface 233. In this embodiment, a seat is no longer required to be defined on the optical bench 130 for a ball lens.

In a further embodiment (not illustrated), a ball lens may be provided (including a corresponding seat provided on the optical bench) to define the desired optical path in conjunction with a structured reflective surface.

In all the above described embodiments, the structured reflective surface may be configured to be flat, concave or convex, or a combination of such to structure a compound reflective surface. In one embodiment, the structured reflective surface has a smooth (polished) mirror surface. It may instead be a textured surface that is reflective. The structured reflective surface may have a uniform surface characteristic, or varying surface characteristics, such as varying degree of smoothness and/or textures across the surface, or a combination of various regions of smooth and textured surfaces making up the structured reflective surface. The structured reflective surface may have a surface profile and/or optical characteristic corresponding to at least one of the following equivalent optical element: mirror, focusing lens, diverging lens, diffraction grating, or a combination of the foregoing. The structure reflective surface may have a compound profile defining more than one region corresponding to a different equivalent optical element (e.g., a central region that is focusing surrounded by an annular region that is diverging).

In one embodiment, the structured reflective surface is defined on an opaque material that does not transmit light through the surface.

As can be appreciated from all of the foregoing, compared to silicon optical benches, the advantages of stamped optical benches include: stamping facilitates high throughput mass production of optical benches at with tight tolerances and lower costs; stamped surface features on the optical benches facilitate precise, passive optical alignment of optical elements and optical components mounted on the optical benches (e.g., light source/sensor, ball lens, optical fiber, etc.), stamping operations yield reflective optics that are already precisely aligned in relation to the stamped surface features; the stamped optics reduce the need for separate optical elements. The stamped optical benches may replace the silicon optical benches in the prior art optical subassemblies of a transmitter (Tx), a receiver (Rx), and/or a transceiver (Tx/Rx).

While the invention has been particularly shown and described with reference to the preferred embodiments, it will be understood by those skilled in the art that various changes in form and detail may be made without departing from the spirit, scope, and teaching of the invention. Accordingly, the disclosed invention is to be considered merely as illustrative and limited in scope only as specified in the appended claims.

We claim:

1. A stamped metal optic for use in an optical communications module, the stamped metal optic comprising:
a unitary, or integrally formed, metal body comprising:
a bench upon which at least one optoelectronic device is mounted in an aligned position; and
a reflector integrally connected to the bench and optically aligned with said aligned position such that an optical axis of the optoelectronic device is in optical alignment with an optical axis of the reflector.

2. The stamped metal optic of clam 1, wherein the reflector is aspherical in shape.

3. The stamped metal optic of claim 2, wherein said at least one optoelectronic device is a laser diode that emits a diverging light beam that is incident on the reflector, and wherein the reflector collimates the diverging light beam into a collimated light beam and reflects the collimated light beam by a nonzero angle relative to an angle of incidence of the diverging light beam on the reflector.

4. The stamped metal optic of claim 3, wherein the nonzero angle is between about 70° and about 110°.

5. The stamped metal optic of claim 4, wherein the nonzero angle is about 90°.

6. The stamped metal optic of claim 1, further comprising:
at least a first ball lens seat formed in the unitary metal body in between the aligned position of the optoelectronic device and the reflector; and at least a first ball lens seated in and fixedly secured to the first ball lens seat, and wherein the reflector is flat in shape, and wherein said at least one optoelectronic device is a laser diode that emits a diverging light beam that is incident on the first ball lens, and wherein the first ball lens collimates the diverging light beam into a collimated light beam and directs the collimated light beam onto the reflector, and wherein the reflector reflects the collimated light beam by a non-zero angle relative to an angle of incidence of the diverging light beam on the reflector.

7. The stamped metal optic of claim 1, wherein the unitary metal body further comprises:
at least a first fiduciary mark formed in the bench adjacent said aligned position of the optoelectronic device.

8. The stamped metal optic of claim 1, wherein at least the reflector is gold plated.

9. The stamped metal optic of claim 1, wherein said at least one optoelectronic device is a photodiode, and wherein the reflector receives a collimated beam of light directed onto the reflector at an angle of incidence and reflects the collimated light beam by a non-zero angle relative to the angle of incidence onto the photodiode.

10. The stamped metal optic of claim 9, wherein the nonzero angle is between about 70° and about 110°.

11. The stamped metal optic of claim 10, wherein the non-zero angle is about 90°.

12. The stamped metal optic of claim 1, further comprising:
at least a first ball lens seat formed in the unitary metal body in between the aligned position of the optoelectronic device and the reflector; and
at least a first ball lens seated in and fixedly secured to the first ball lens seat, and wherein the reflector is flat in shape, and wherein said at least one optoelectronic device is a photodiode, and wherein the reflector receives a collimated light beam that is incident on the reflector at an angle of incidence and reflects the received collimated light beam onto the first ball lens at a non-zero angle relative to the angle of incidence, and wherein the first ball lens focuses the collimated light beam received thereby onto the photodiode.

13. The stamped metal optic of claim 12, wherein the unitary metal body further comprises:
at least a first fiduciary mark form in the bench adjacent said aligned position of the optoelectronic device, the fiducial mark containing alignment information for mounting the optoelectronic device on the bench.

14. The stamped metal optic of claim 12, wherein at least the reflector is gold plated.

15. The stamped metal optic of claim 1, wherein a plurality of optoelectronic devices are mounted on the bench in respective aligned positions, and wherein the reflector is optically aligned with all of the aligned positions such that respective optical axes of the optoelectronic devices are in optical alignment with optical axes of the reflector.

16. The stamped metal optic of claim 1, wherein the optical communications module is an optical transmitter module.

17. The stamped metal optic of claim 1, wherein the optical communications module is an optical receiver module.

18. The stamped metal optic of claim 1, wherein the optical communications module is an optical transceiver module.

19. The stamped metal optic of claim 1, wherein the optical communications module is a transistor-outline (TO) can assembly.

20. The stamped metal optic of claim 1, wherein the unitary metal body further comprises:
at least a first passive alignment device formed in the bench for passively aligning the optoelectronic device on the bench in said aligned position.

21. A method for forming a stamped metal optic for use in an optical communications module, the method comprising:
performing a sheet metal stamping process on a sheet metal work piece to form a plurality of stamped metal optics in the sheet metal work piece, each stamped metal optic comprising:
a unitary, or integrally formed, metal body comprising:
a bench upon which at least one optoelectronic device is mounted in an aligned position; and
a reflector integrally connected to the bench and optically aligned with said aligned position such that an optical axis of the optoelectronic device is in optical alignment with an optical axis of the reflector.

22. The method of claim 21, wherein the reflector is aspherical in shape.

23. The method of claim 21, further comprising:
mounting at least a first optoelectronic device on the bench.

24. The method of claim 23, wherein the unitary metal body further comprises at least a first ball lens seat formed in the unitary metal body in between the aligned position of the optoelectronic device and the reflector, and wherein the method further comprises:
mounting a first ball lens on the first ball lens seat and securing the first ball lens to the first ball lens seat.

25. The method of claim 21, further comprising:
performing a shearing process to singulate the stamped metal optics from the sheet metal work piece.

26. The method of claim 25, further comprising:
performing a plating process to plate the reflectors of the stamped metal optics with a reflective metal.

27. The method of claim 26, wherein the reflective metal is gold.
